(19) United States
(12) Patent Application Publication
(10) Pub. No.: US 2013/0186371 A1
(43) Pub. Date: Jul. 25, 2013

(54) METHOD FOR INCREASING A FATIGUE STRENGTH OF A HOLLOW BODY, AND ASSOCIATED HOLLOW BODY

(71) Applicant: Veritas AG, Gelnhausen (DE)

(72) Inventor: Sergio Pascuzzi, Gelnhausen (DE)

(73) Assignee: VERITAS AG, Gelnhausen (DE)

(21) Appl. No.: 13/745,972

(22) Filed: Jan. 21, 2013

(30) Foreign Application Priority Data
Jan. 20, 2012 (DE) 10 2012 001 076.1

(51) Int. Cl. F02M 69/50

(52) U.S. Cl. CPC F02M 69/50
USPC 123/456; 427/427.5; 156/60; 156/86

(57) ABSTRACT

A method for increasing a fatigue strength of a hollow body with respect to internal pressure and to such a hollow body itself. For this purpose, the hollow body has a plastic encapsulation which is applied in a sealing layer to a circumferential surface of the hollow body.

### CROSS-REFERENCE TO RELATED APPLICATIONS

This application is the U.S. national phase of German Appln. No. DE10 2012 001 076.1 filed on Jan. 20, 2012.

### TECHNICAL FIELD

The invention relates to a method for increasing a fatigue strength of a hollow body with respect to internal pressures in particular to a hollow fuel distributor rail.

### BACKGROUND

The distribution of fuel to individual cylinders of an internal combustion engine is performed conventionally by means of a distributor rail which is arranged in the vicinity of a cylinder head. In conventional internal combustion engines, for the required low pressures of no greater than 10 bar, wall thicknesses of no greater than 1 mm are used for the distributor rails, with high-grade steel preferably being used. In particular in the case of direct-injection applied-ignition engines with fuel pressures of up to over 150 bar, at present, for durability reasons owing to temperature and pressure loading and owing to the chemical stress caused by the fuel (in particular when biogenic fuels are used), thick-walled distributor rails of this type are used which are produced from thick-walled, partially soldered components. This yields both weight and cost disadvantages and also disadvantages with regard to variety, integration of attachment parts or additional functions.

During the course of the optimization of internal combustion engines by increasing the injection pressures in the case of diesel engines to over 2000 bar, it is conventional to carry out component strengthening, which results in increased load capacity. Here, it is preferable for a residual compressive stress to be applied in the components to be strengthened, whereby the fatigue strength of the component can be increased. Here, the component, after being produced, is subjected to an internal pressure which is higher than the later operating pressure and higher than the yield strength, which internal pressure causes regions of an inner wall to plasticize, whereby residual compressive stresses are induced in said region. Such follow-up treatment is expensive and time-consuming.

The disadvantages described above thus yield the object of the present invention, that of providing and further developing a distributor rail of the type specified in the introduction, the fatigue strength of which distributor rail is improved, even with weight and cost advantages, in relation to the prior art.

### SUMMARY

A method for achieving the above-stated object has the features of independent claim 1. According to said claim, a method for increasing a residual compressive stress of a hollow body, in particular of at least one metal pipe, is proposed, in which a compressive stress is induced on an inner side of the hollow body, with a pressure being applied to at least one part of an outer circumferential surface of the hollow body, and wherein the hollow body is encapsulated with plastic for the application of the pressure to the outer circumferential surface. As a result of the encapsulation of the hollow body with a plastic, it is possible in particular to realize weight savings in relation to the prior art, because firstly the metal pipe is thinner than in the case of a single-shell variant of a distributor rail, and secondly, the plastic itself is lighter than a comparable metallic material. Furthermore, with the application of a plastic to the hollow body and the associated thinner form of the hollow body, advantages in terms of variety can also be attained. With the application of the pressure to the outer circumferential surface of the hollow body by the plastic, it is possible to dispense with the plasticizing after the production of the component as described in the prior art, wherein the plastic itself applies the pressure to the outer circumferential surface.

In one preferred exemplary embodiment of the invention, the plastic can be sprayed onto and/or applied in similar fashion to the hollow body, or a plastic pipe or plastic line can be pulled onto the hollow body. Accordingly, a large degree of variability exists in terms of the shape of the plastic which encapsulates the metal pipe. Here, the invention provides several forms of application, wherein the plastic may be on the one hand sprayed on or on the other hand also extruded on, and furthermore the plastic may be wound in the manner of a strip around the metal pipe. In addition, the method according to the invention also provides the pulling of a plastic pipe or a plastic line onto the hollow body such that the hollow body is surrounded at least partially over the entire area, preferably over the entire area, by the plastic.

In one preferred refinement of the invention, the plastic layer or the plastic pipe or the plastic line can solidify or harden after being applied to the hollow body. In the method according to the invention, there is in particular provision for the plastic to be applied to the hollow body in a state of aggregation which permits a solidification or hardening after the application. Depending on the selected plastic—thermoplastics and thermosets may be used—the plastic solidifies or hardens on the hollow body. It is advantageously provided here, in the case of plastic pipes or lines, that these are provided to be slightly larger than an outer circumference of the metal pipe, such that the plastic encapsulation can be applied easily to the metal pipe.

In one refinement of the invention, during the solidification or hardening, the plastic layer or the plastic pipe or the plastic line shrinks and thereupon bears in a frictionally engaging manner at least partially, or in a partially positively locking manner, against the outer circumferential surface of the hollow body. In this way, the plastic layer or the plastic pipe or the plastic line is situated on the metal pipe with an interference fit, as a result of which it bears over the full area against the outer circumferential surface. In addition or alternatively, the plastic used may also undergo a reduction in volume during hardening or solidification.

In one particular embodiment of the invention, a pressure, in particular a uniform pressure, can be exerted on the outer circumferential surface of the hollow body by the solidified or hardened plastic layer or the plastic pipe or the plastic line. The plastic which is situated on the hollow body with an interference fit exerts a pressure on the metal pipe, which pressure causes a residual compressive stress of the hollow body to be increased. In this way, it is possible in particular for the fatigue strength of the component under internal pressure loading to be increased. In particular, the plastic which is applied tightly to the outer circumferential surface of the hollow body induces a compressive stress in the metal layer of the metal pipe, which compressive stress is similar to the effect of autofrettage in the case of pure metal components.

With the method according to the invention, it is advantageously also possible for at least two hollow body parts to be assembled to form a hollow body, said at least two hollow body parts being encapsulated with a continuous plastic layer, with a force for holding the two hollow body parts together being applied by the plastic layer. Distributor rails are conventionally formed by a plurality of components which are mounted on one another at corresponding contact portions. By contrast to the prior art, it is the case with the present method that the components are held together by the plastic layer, such that it is possible to dispense with a separate soldered connection of the components. With a seal arranged between the respective components, it is possible for an escape of fuel or other liquids from the hollow body to be prevented, wherein also in particular the high pressures can have no adverse effect on the sealing action. Furthermore, the plastic layer is situated on the metal pipe with a particularly strong interference fit, whereby said metal pipe, even in the case of a hollow body composed of a plurality of assembled parts, experiences an increase in residual compressive stress and thus an increase in fatigue strength of the component.

It may furthermore advantageously be provided that, during the encapsulation with the plastic, in the region of the outer circumferential surface, at least one functional unit, in particular a sensor, an actuator or the like, can be at least partially jointly encapsulated. For this purpose, before the application of the plastic layer to the hollow body, one or more functional units are arranged on the hollow body such that the respective functional unit is positioned preferably between the hollow body and the plastic layer. A functional unit may be used either for measuring for example a fuel pressure or a temperature or else for actuating a pressure-maintaining valve within the distributor rail. Furthermore, other arrangements of the functional unit in the region of the hollow body or of the plastic layer are also conceivable. It may for example be provided that the functional unit is arranged not directly on the hollow body but rather within the plastic layer, such that the functional unit is embedded in the plastic layer.

The present invention is also achieved by means of a hollow body having the features of independent claim 8. According to said claim, the hollow body, in particular a fuel distributor rail, has at least one elongate metal inner pipe and a plastic encapsulation which surrounds the inner pipe at least in sections, with the hollow body having at least one opening, and wherein a force is applied by the plastic encapsulation to the inner pipe. Here, the plastic encapsulation is seated on the inner pipe with an interference fit, said inner pipe being subjected to compressive loading by the inwardly directed tensile forces of the plastic encapsulation. The fatigue strength of the component, in particular of the metal inner pipe, can be increased in this way.

In one preferred embodiment of the invention, the encapsulation may be a plastic, in particular a thermoplastic or a thermoset, with the encapsulation being capable of shrinking when it solidifies or hardens. The plastic which is applied to the inner pipe may basically be selected arbitrarily, wherein only the shrinkage behavior of the plastic is crucial. Thermoplastics have such a shrinkage effect when they solidify during cooling. A similar behavior is exhibited by thermosets, which likewise shrink during hardening and thus, with corresponding dimensioning, exert pressure on the inner pipe, which is held durably even in the solid state of the plastic.

In one preferred refinement of the invention, the encapsulation can exert a pressure on the inner pipe, which pressure increases a residual compressive stress of the inner side of the hollow body. Depending on the magnitude of the shrinkage process with the selected plastic and the dimensioning of the plastic encapsulation, the force introduced by the plastic encapsulation may be so high that the inner side of the inner pipe experiences an increase in the residual compressive stress. In this way, the fatigue strength of the component is increased, and the load capacity at elevated internal pressures is increased.

In one refinement of the invention, the inner pipe may be formed at least from two pipe portions which are connected to one another at corresponding portions, with the pipe portions being held together by the encapsulation. For structural reasons, fuel distributor rails are preferably assembled from a plurality of components, such that an interface between two adjacent pipe portions must be joined together. For this purpose, the encapsulation is arranged on the two adjacent pipe portions such that these are held together with a type of interference fit. In particular, it is possible for a particularly firm connection of two pipe portions to be produced by means of the shrinkage process of the plastic encapsulation. For this purpose, the inner pipe, composed of at least two pipe portions, has a unitary or single-piece plastic encapsulation.

It is particularly preferably possible for a seal to be arranged in the region of corresponding portions, which seal prevents the escape of fuel or other liquids. Such a seal may furthermore serve as an additional support ring for the respective pipe portions, whereby improved accuracy of fit of the pipe portions which bear against one another can be attained.

In one preferred refinement of the invention, the encapsulation may have a fiber reinforcement. Fibers which are introduced into the encapsulation increase the durability of the plastic encapsulation, in particular if pressure is exerted on the encapsulation by the high pressures within the hollow body. Here, the fibers may be arranged loosely or in an ordered manner or as a type of fiber mat on the encapsulation.

In a further exemplary embodiment, the hollow body may have additional openings for the connection of lines or valves. Here, the plastic encapsulation is arranged on the hollow body such that the openings remain free, and any projections are at least partially jointly encapsulated.

In one particular refinement of the invention, at least one functional unit, in particular a sensor, an actuator or the like, may be arranged in the region of the encapsulation, preferably partially between the inner pipe and the encapsulation. The two-part construction of the hollow body with an inner pipe and a surrounding plastic encapsulation advantageously permits the arrangement of additional devices between the inner pipe and the plastic encapsulation. Alternatively, such a functional unit may also be arranged within the encapsulation, such that the functional unit does not bear directly against the inner pipe.

Further advantageous embodiments of the method and of the device emerge from the dependent claims.

### BRIEF DESCRIPTION OF THE DRAWINGS

A preferred exemplary embodiment of the invention will be explained in more detail below on the basis of the figures, in which:

FIG. 1: shows a fuel distributor rail as per a first exemplary embodiment, and

FIG. 2: shows a section through a partial region of the fuel distributor line with a metal insert and seal groove.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

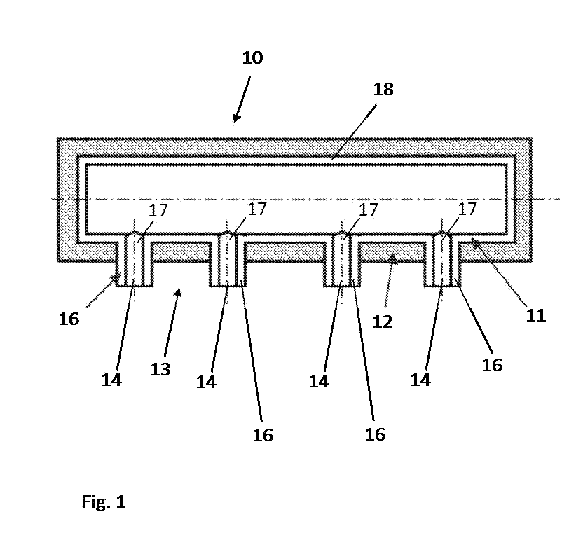

A distributor rail 10 of the present invention is illustrated in FIG. 1, said distributor rail having an inner pipe 11 and having an encapsulation 12 surrounding the inner pipe 11. On a longitudinal side 13, in the longitudinal extent of the distributor rail 10, there are arranged four openings 14 which preferably point in one direction.

The openings 14 are provided both in the inner pipe 11 and also in the encapsulation 12, wherein the inner pipe 11 has, in the region of the openings 14, sleeves 16 which are placed in engagement in recesses 17 of the inner pipe 11. The specific manner of connection of the sleeves 16 will be explained in yet more detail below.

The inner pipe 11 is preferably a metal pipe composed of a high-grade steel, which is resistant to chemical influences. The use of biogenic fuels increases the stress on conventionally used metal pipes to an unknown extent, for which reason present distributor rails 10 must satisfy the new demands. Furthermore, the inner pipes 11 must also be temperature-resistant because an elevated temperature prevails in addition to the elevated pressure within the distributor rail 10. It has therefore proven to be expedient to use high-alloyed, rust-resistant steels for distributor rails 10.

In the exemplary embodiment, the inner pipe 11 is provided with an encapsulation 12 which covers at least a predominant part of an outer circumferential surface 18 of the inner pipe 11. Cutouts are provided in the encapsulation 12 in the region of the openings 14. FIG. 1 illustrates the distributor rail 10 in schematic form, such that the angular representation should be understood merely as an example. Both the inner pipe 11 and also the encapsulation 12 may have a more rounded shape. In particular, the distributor rail 10 may be of any shape and have more or fewer openings 14.

The encapsulation 12 is composed preferably of a plastic, which is likewise temperature- and chemical-resistant. The encapsulation is preferably a homogeneous structure which exerts stress uniformly over the circumferential surface of the inner pipe 11. Here, the encapsulation 12 bears tightly against the circumferential surface, whereby a frictionally engaging connection of the inner pipe 11 and encapsulation 12 is produced. As a result of said interference fit, the encapsulation is arranged, such that it cannot slip, on the inner pipe 11, resulting in a stable unit composed of two components forming a distributor rail 10. By contrast to single-piece distributor rails, the distributor rail 10 according to the invention is also referred to as an “assembled” distributor rail.

The plastic may be of any type and quality as long as it ensures the said frictionally engaging contact of the encapsulation 12 with the inner pipe 11. For this purpose, use is made primarily of thermoplastics and thermosets which satisfy the demands on material properties. Both plastics may be applied by means of simple method steps to the inner pipe 11, where the encapsulation 12 assumes its interference fit on the inner pipe 11.

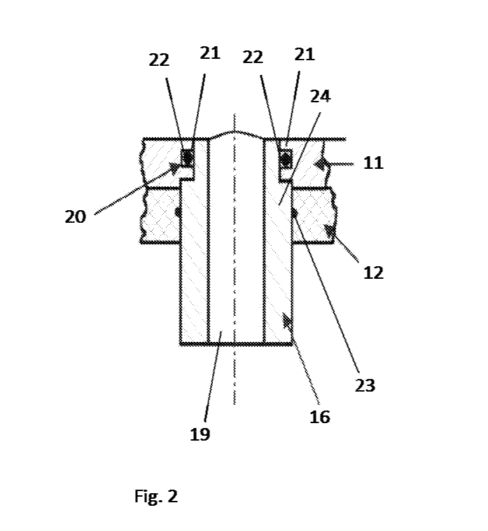

The inner pipe 11 has one or more recesses 17 in which is arranged in each case one sleeve 16, as illustrated in FIGS. 1 and 2. The sleeve 16 has a central passage opening 19 which produces a connection from an inner side of the inner pipe 11 to an environment. The sleeve 16 in the present exemplary embodiment is to be understood as an example, because other components such as for example valves or measurement sensors which may have a different shape than the illustrated sleeve 16 may also be arranged in the recesses 17.

The sleeve 16 is held in the recess 17 of the inner pipe by the plastic encapsulation 12. Here, the encapsulation 12, which has been reduced in size by the shrinkage process, exerts a holding force on the sleeve 16, which holding force ensures that the components are held together firmly. By means of the interference fit, it is possible for the components to be connected to one another in such a way that a separate seal between the components can be dispensed with. The fuel distributor rail 10 is thus sealed with respect to a possible escape of fuel, and it is possible to dispense with expensive soldering processes or seals.

It is nevertheless the case in other embodiments that a seal 20 is provided between the two components in the region of two corresponding contact portions. Such a seal increases the reliability of the desired sealing action and reduces the holding requirements on the plastic encapsulation 12. In the latter case, owing to the additional seal 20, it is possible to select an encapsulation 12 with a reduced shrinkage effect, which may result in a cost and/or monetary advantage. Furthermore, the seal 20 may also serve as a type of guide by means of which the two components are more easily connected to one another during the production process.

The seal 20 itself may be provided as a conventional ring seal such as is known from the prior art. For this purpose, there is provided in the inner pipe 11 an encircling groove 21 in which a seal ring 22 is arranged. The seal ring 22 is in turn in frictionally engaging contact with the sleeve 16, which is in engagement with the inner pipe 11. Other forms of seal may however likewise be provided. To increase the sealing action, a seal 23 may also be provided in the region of a contact surface between the sleeve 16 and the surrounding encapsulation 12. For this purpose, the sleeve 16 may have, in a contact region 24, an encircling recess which is surrounded at the outside by the encapsulation 12. On the other hand, it is also possible for a detachable sealing ring to be provided in the contact region, which sealing ring is at least additionally pressed against the seal 16 by the surrounding encapsulation 12 after the shrinkage process. A fixedly installed seal 23 in the contact region 24 furthermore provides the encapsulation 12 with a holding point, because as a result of the shrinkage effect, the plastic engages behind the seal 23, and thus an additional force direction is generated. In this way, the sleeve 16 is pressed more effectively in the direction of the recess 17 by the encapsulation 12.

A further possibility for arranging the sleeves 16 in the inner pipe 11 and holding them there is for the sleeves 16 to be pressed into the recesses 17, or else for the sleeves 16 to be soldered to the inner pipe 11. In the case of said holding measures, the plastic encapsulation 12 has merely a supporting function.

As already described, the plastic which is arranged on the outer circumferential surface 18 of the inner pipe 11 applies a force to the inner pipe. After the hardening or solidification, the encapsulation 12 bears against the inner pipe 11 with an interference fit because the plastic has shrunk during the hardening or solidification. However, not only does the compressive force of the encapsulation hold the sleeves 16, but rather the compressive force also counteracts the pressures of 100 bar and higher expected in the distributor rail 10. The distributor rail 10 according to the invention has a thinner metal pipe in relation to the prior art, which metal pipe on its own can withstand the intended pressures at least only to a limited extent. The encapsulation 12 thus increases the operational capability of the distributor rail 10, because in particular a fatigue strength of the distributor rail 10 is increased in this way.

The pressure exerted on the inner pipe 11 by the encapsulation 12 furthermore effects an increase in a residual compressive stress of the inner pipe 11. As a result of an increase in the residual compressive stress of the inner pipe 11, it is possible for higher pressures to be accommodated in the distributor rail 10. The shrinkage process results in tensile stresses and compressive stresses in the circumferential direction of the plastic encapsulation 12 in the circumferential direction of the inner pipe 11, wherein, during operation of the distributor rail 10, in the case of intensely pulsating pressures, the compressive stress in the inner pipe 11 is superposed on the tensile stresses generated by the pressure prevailing in the interior of the pipe 11. As a result, the tensile stress in the inner pipe 11 is reduced by the magnitude of the artificially increased compressive stresses in the inner pipe 11, resulting in an improvement in the fatigue strength of the distributor rail 10.

In an alternative exemplary embodiment of the invention (not illustrated in the figures), to further boost the pressure generated on the inner pipe 11, fibers are inlaid in the encapsulation. Here, the fibers may be arranged loosely or in an ordered manner in the plastic. In particular in the case of fibers oriented in a defined way, it is possible for tensile forces caused by the inner pipe 11 to be accommodated in a targeted manner in the encapsulation which is reinforced by the fibers. It is preferably also possible for fiber mats to be used for this purpose.

Different methods are proposed for increasing the residual compressive stress in the inner pipe 11. It is proposed in one exemplary embodiment of the invention that the plastic in the form of a thermoplastic or a thermoset (duroplast) be sprayed onto the outer circumferential surface 18 of the inner pipe 11, whereby a substantially uniform coating of the inner pipe 11 is attained. To attain the demanded thickness of the encapsulation 12, that is to say of a plastic layer, it may be necessary for the plastic to be sprayed on in multiple layers. A homogeneous encapsulation must be ensured here.

In a second method step, the applied plastic will harden or solidify depending on the type of plastic, wherein in the process, the encapsulation 12 shrinks and tensile stresses are generated within the plastic.

In the case of thermosets, chain molecules form during the hardening process, which chain molecules also crosslink three-dimensionally with one another, as a result of which the shape of the plastic does not change again after hardening. During the hardening process, the shaped part to be hardened, in the form of the encapsulation 12, is heated, wherein the desired shrinkage occurs. Shrinkage is likewise exhibited by thermoplastics, in which chain molecules likewise form (not as strongly as in thermosets).

In a further exemplary embodiment, the encapsulation 12 is applied in the form of a hose to the inner pipe 11. Here, the inner pipe 11 initially has a smaller diameter than the hose, such that components can be easily joined together. The hose is heated on the inner pipe 11, as a result of which said hose both hardens and also shrinks, such that the hose surrounds the inner pipe 11 with an interference fit as an encapsulation 12.

In the distributor rail 10 there may also be provided functional units which are arranged in the region of the encapsulation 12. The functional units may be actuators, sensors or the like. The actuators may be used for example for actuating valves in the distributor rail 10, whereas the sensors measure for example the pressure prevailing in the inner pipe 11 or else the temperature. Here, the functional units may be located either between the inner pipe 11 and the encapsulation 12 or else within the encapsulation 12 without being in direct contact with the inner pipe 11. Intermediate solutions are likewise possible, in which for example a sensor is in contact with the outer circumferential surface 18 of the inner pipe 11, but another part is arranged within the encapsulation 12. In this way, it is possible to dispense with a retroactive assembly of distributor rail 10 and external functional units.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for increasing a fatigue strength of a hollow body with respect to internal pressures, in particular of at least one metal pipe, with a compressive stress being induced on an inner side of the hollow body, and a pressure being applied to at least one part of an outer circumferential surface of the hollow body, wherein the hollow body is encapsulated with plastic for the application of the pressure to the outer circumferential surface.

2. The method as claimed in claim 1, wherein the plastic is sprayed onto and/or applied in similar fashion to the hollow body, or a plastic pipe or plastic line is pulled onto the hollow body.

3. The method as claimed in claim 1, wherein the plastic layer or the plastic pipe or the plastic line solidifies or hardens after being applied to the hollow body.

4. The method as claimed in claim 1, wherein, during the solidification or hardening, the plastic layer or the plastic pipe or the plastic line shrinks and thereupon bears in a frictionally engaging manner at least partially against the outer circumferential surface of the hollow body.

5. The method as claimed in claim 1, wherein a pressure, in particular a uniform pressure, is exerted on the outer circumferential surface of the hollow body by the solidified or hardened plastic layer or the plastic pipe or the plastic line.

6. The method as claimed in claim 1, wherein at least two hollow body parts are assembled to form a hollow body, said at least two hollow body parts being encapsulated with a continuous plastic layer, with a force for holding the two hollow body parts together being applied by the plastic layer.

7. The method as claimed in claim 1, wherein, during the encapsulation with the plastic, in the region of the outer circumferential surface, at least one functional unit, in particular a sensor, an actuator or the like, is at least partially jointly encapsulated.

8. A hollow body, in particular a fuel distributor rail, which has at least one elongate metal inner pipe and a plastic encapsulation which surrounds the inner pipe at least in sections, with the hollow body having at least one opening, wherein a force applied by the plastic encapsulation to the inner pipe.

9. The hollow body as claimed in claim 8, wherein the encapsulation is a plastic, in particular a thermoplastic, with the encapsulation being capable of shrinking when it solidifies or hardens.

10. The hollow body as claimed in claim 8, wherein the encapsulation exerts a pressure on the inner pipe, which pressure increases a residual compressive stress of the inner side of the hollow body.

11. The hollow body as claimed in claim 8, wherein the inner pipe is formed at least from two pipe portions which are connected to one another at corresponding portions, with the pipe portions being held together by the encapsulation.

12. The hollow body as claimed in claim 8, wherein a seal is arranged in the region of the corresponding portions.

13. The hollow body as claimed in claim 8, wherein the encapsulation has a fiber reinforcement.

14. The hollow body as claimed in claim 8, wherein the hollow body has additional openings for the connection of lines or valves.

15. The hollow body as claimed in claim 8, wherein at least one functional unit, in particular a sensor, an actuator or the like, is arranged in the region of the encapsulation, preferably at least partially between the inner pipe and the encapsulation.
